(19) United States
(12) Patent Application Publication
(10) Pub. No.: US 2026/0205837 A1
(43) Pub. Date: Jul. 16, 2026

(54) Aggregation Level Adaptation in Radio Link Monitoring

(71) Applicant: Apple Inc., Cupertino, CA (US)

(72) Inventors: Jie Cui, San Jose, CA (US); Yang Tang, San Jose, CA (US); Haitong Sun, Saratoga, CA (US); Qiming Li, Beijing (CN); Dawei Zhang, Saratoga, CA (US); Hong He, San Jose, CA (US); Chunxuan Ye, San Diego, CA (US)

(21) Appl. No.: 18/861,537

(22) PCT Filed: Oct. 31, 2023
(86) PCT No.: PCT/CN2023/128376

§ 371 Date: Oct. 29, 2024

(51) Int. Cl. H04W 24/08

(52) U.S. Cl. CPC H04W 24/08

(57) ABSTRACT

An apparatus of a user equipment (UE) comprising one or more processors coupled to a memory and configured to decode, from signaling received from a next generation node B (gNB), an indication for a radio link monitoring in-sync aggregation level parameter; decode downlink control information in a physical downlink shared channel from the gNB with a selected number of control channel elements, based on the aggregation level parameter, and perform one of an in-sync evaluation or an out of sync evaluation based on the radio link monitoring in-sync aggregation level parameter.

### FIELD

Embodiments of the invention relate to wireless communications, including apparatuses, systems, and methods for setting an aggregation level.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) has been the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. In 2015, a study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

Aggregation levels for downlink control information (DCI) in physical downlink control channels for various channel bandwidths are typically identified in the 3GPP NR specification. However, certain aggregation levels set in the specifications for selected bandwidths may make it difficult to determine whether the DCI received in the PDCCH is received in-sync or out-of-sync.

### SUMMARY

Embodiments relate to wireless communications, and more particularly to apparatuses, systems, and methods for an apparatus of a user equipment (UE), the apparatus comprising one or more processors, coupled to a memory, configured to: decode, from signaling received from a next generation node B (gNB), an indication for a radio link monitoring (RLM) in-sync (IS) aggregation level (AL) parameter; decode downlink control information (DCI) in a physical downlink shared channel (PDCCH) from the gNB with a selected number of control channel elements (CCEs) based on the AL parameter; and perform one of an in-sync (IS) evaluation or an out-of-sync (OOS) evaluation based on the RLM IS AL parameter.

Other embodiments relate to an apparatus of a user equipment (UE), the apparatus comprising: one or more processors, coupled to a memory, configured to: decode, from signaling received from a next generation node B (gNB), one or more reference signals; determine a signal to interference plus noise ratio (SINR) of the one or more reference signals; select a radio link monitoring (RLM) in-sync (IS) aggregation level (AL) parameter based on the SINR; and perform one of an in-sync evaluation or an out-of-sync evaluation based on the RLM IS AL parameter.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates an example diagram of a channel bandwidth for 3GPP NR according to some embodiments.

FIG. 9 illustrates an example diagram of a CORESET in a bandwidth part (BWP) according to some embodiments.

FIG. 10 illustrates an example diagram of the abstraction layers used for communication of radio link monitoring according to some embodiments.

FIGS. 11a and 11b illustrate an example of PDCCH transmission parameters for out-of-sync and in-sync evaluation for bandwidths less than 5 MHz according to some embodiments.

FIG. 12 illustrates and example of ALs set in the specification for predetermined uses according to some embodiments.

FIG. 13 illustrates an example diagram of curves for block error rate (BLER) (percent) versus signal to interference plus noise ratio (SINR), in decibels (dB) for a PDCCH transmission for selected aggregation levels according to some embodiments.

FIG. 14 illustrates an example of pseudo-code for an information element for RRC signaling to configure AL for OOS and IS evaluation in RLM resources according to some embodiments.

FIG. 15 illustrates an example of pseudo-code for an information element for RRC signaling to configure AL for OOS and IS evaluation in RLM resource configuration according to some embodiments.

FIG. 16 illustrates an example of pseudo-code for an information element for network indication-based AL level selection for RLM according to some embodiments.

FIG. 17 illustrates an example of two PDCCH curves showing the BLER (%) vs SINR (dB) according to some embodiments.

FIG. 18 illustrates an example flow chart of a method for setting an aggregation level, according to some embodiments.

FIG. 19 illustrates an example flow chart of a method for setting an aggregation level, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1(FR1 ) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to configuring intra-frequency and inter-frequency RRM measurement for UEs supporting bandwidth part (BWP) without restriction.

The example embodiments are described with regard to communication between a next generation Node B (gNB) and a user equipment (UE). However, reference to a gNB or a UE is merely provided for illustrative purposes. The example embodiments may be utilized with any electronic component that may establish a connection to a network and is configured with the hardware, software, and/or firmware to support gapless RRM measurements. Therefore, the gNB or UE as described herein is used to represent any appropriate type of electronic component.

The example embodiments are also described with regard to a fifth generation (5G) New Radio (NR) network that may configure a UE to have a selected aggregation level for control channel elements in physical downlink control channels with a bandwidth of less than 5 MHz.

Throughout this description various information elements (IEs) are referred to by specific names. It should be understood that these names are only examples and the IEs carrying the information referred to throughout this description may be referred to by other names by various entities.

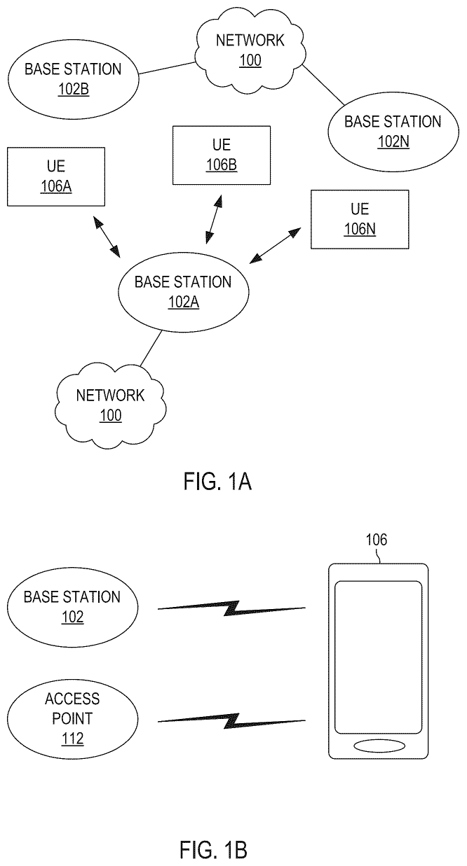

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

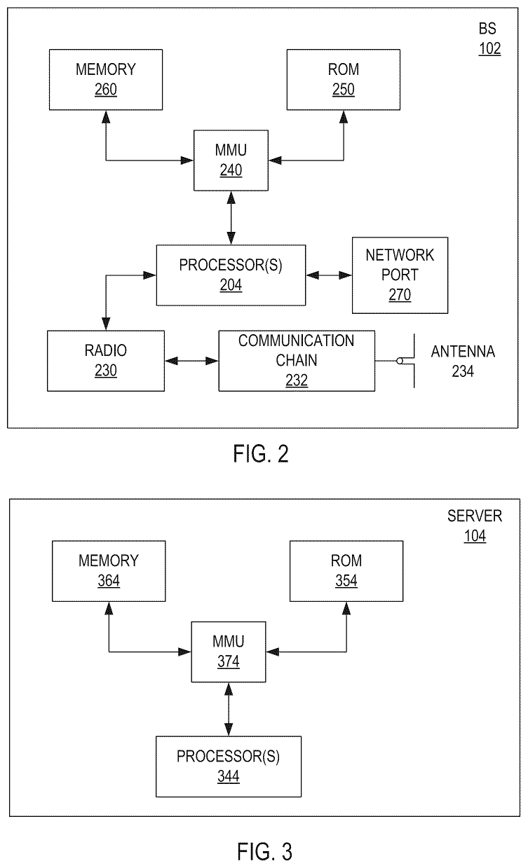

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station or gNB 102, and/or processors 204 thereof, can be capable of and configured to decode indications from the UE 106, determine UE capabilities based on the indications, and encode for transmission to the UE 106 downlink signals to enable the UE 106 to perform measurements of the target SSB without gap or gapless measurement.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

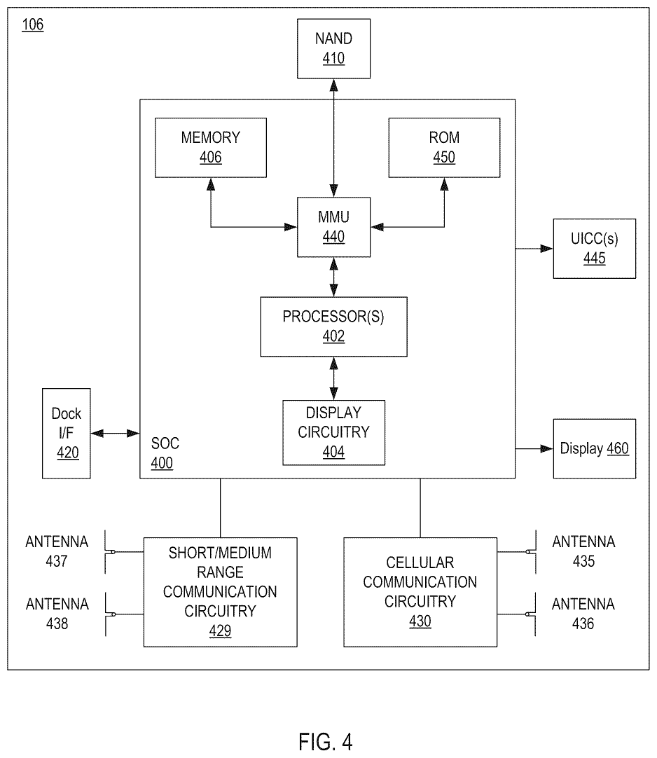

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMS may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 and/or the processors 402 thereof can be configured to and/or capable of performing various operations related to adjusting an aggregation level for radio link monitoring.

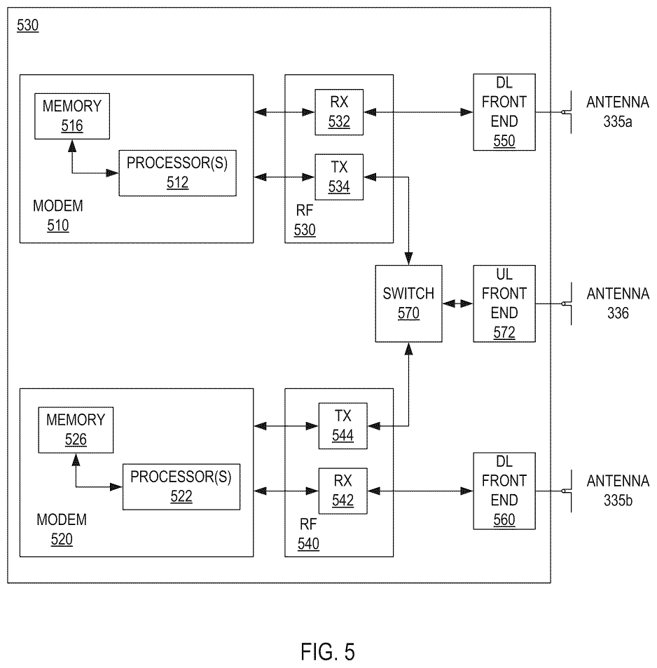

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

In some embodiments, the processors 512, 522 can be configured for adjust an aggregation level for radio link monitoring, as further described herein.

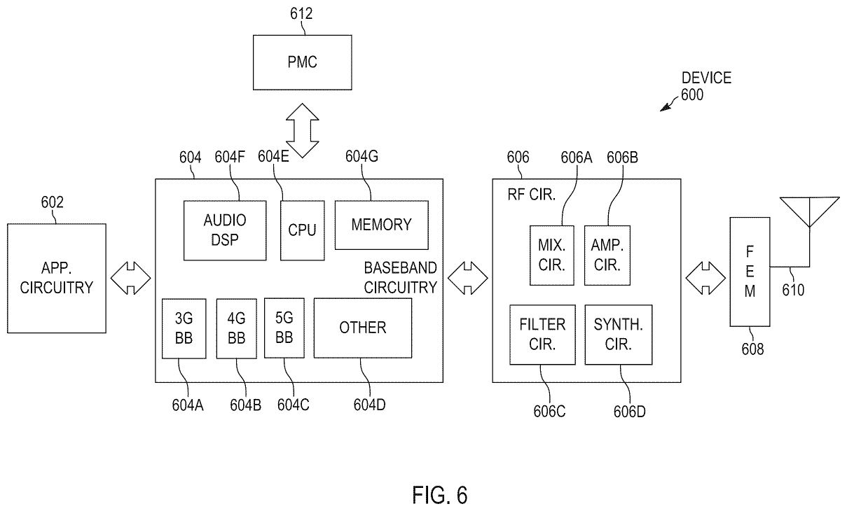

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuity 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it will transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below. Accordingly, the baseband circuitry 604 can be used to encode a message for transmission between a UE and a gNB, or decode a message received between a UE and a gNB.

For example, the baseband circuitry 604 can be used to decode, from signaling received from a gNB, an indication for a RLM IS AL parameter. The baseband circuitry 604 can also be used to decode DCI in a PDCCH from the gNB with a selected number of CCEs based on the AL parameter. These examples are not intended to be limiting. The baseband circuitry can be used as previously described.

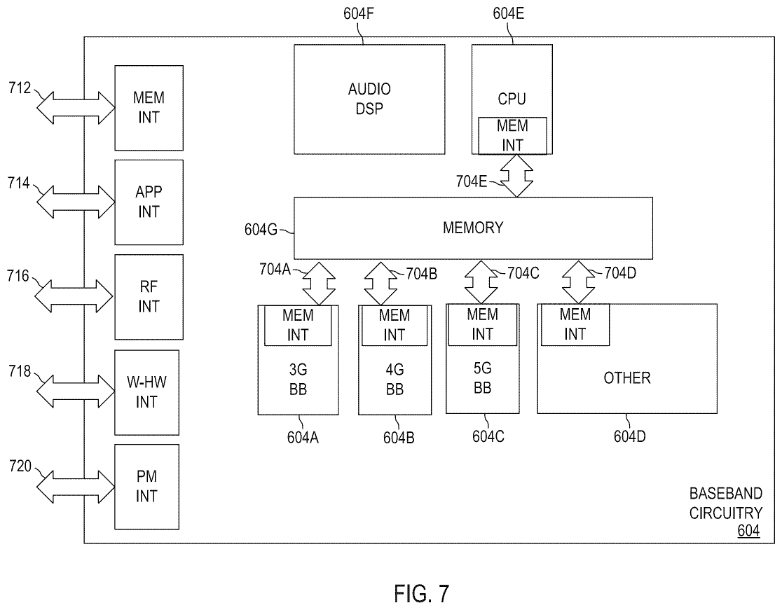

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 7914 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

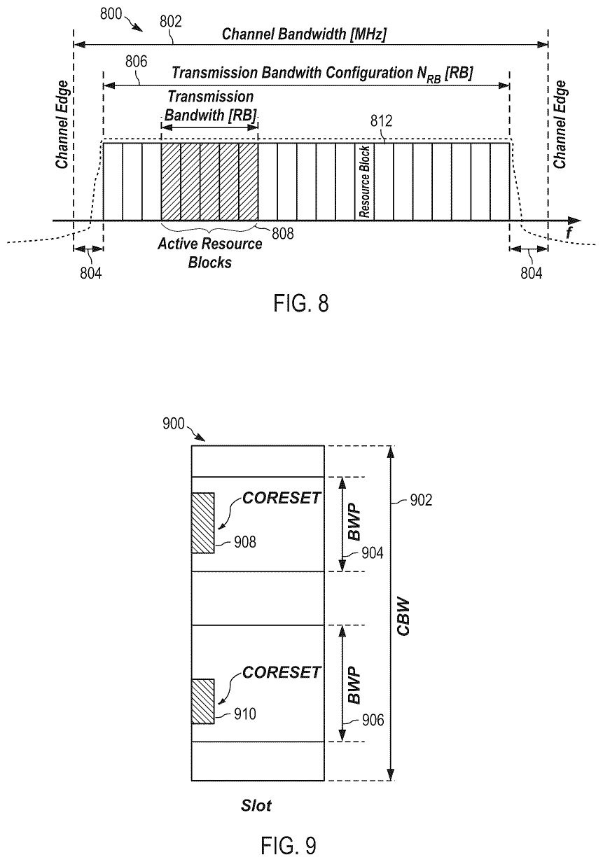

### FIG. 8: NR Channel Bandwidth

NR is designed to enable UEs to use different bandwidths. FIG. 8 illustrates an example diagram 800 of a channel bandwidth and the maximum transmission bandwidth configuration for one NR channel. This illustration is provided in Table 5.3.3-1 in 3GPP Technical Specification (TS) 38.101. In this example, a total channel bandwidth 802 is comprised of a transmission bandwidth 806 comprising N resource blocks (RB) and guardband 804 on each side of the transmission bandwidth 802. The channel bandwidth 802 is approximately equal to the number of resource blocks 812 times the number of subcarriers times the subcarrier spacing (SCS) plus the guardband width times 2. The number of subcarriers in NR is predefined as 12.

The subcarrier spacing in NR is defined as 15 kilohertz (kHz), 30 kHz, or 60 kHz in Frequency Range 1(FR1 ). The number of RB can be selected for each SCS to provide a maximum transmission bandwidth between 5 MHz (25 RB at an SCS of 15 kHz) and 100 MHz (135 RB at an SCS of 60 kHz). Additional bands are available in the Frequency Range 2 (FR2 ). The transmission bandwidth 806 can be further reduced to a selected group of physical resource blocks (PRBs), referred to as the active resource blocks 808. The active resource blocks provide a bandwidth part (BWP) of the transmission bandwidth 806. A UE can communicate using one or more BWPs within the transmission bandwidth 806. A BS can select which BWP is active.

At the physical layer, the data and signaling information in NR are carried in the downlink (DL) and uplink (UL) physical channels. One of these channels, the physical downlink control channel (PDCCH) is used, in part, to provide DL scheduling and UL scheduling grants.

The information carried in the PDCCH is referred to as downlink control information (DCI). DCI includes the scheduling information for the UL or DL data channels and other control information for one or more UEs. Modulated symbols of DCI information are mapped to physical resources in units referred to as control channel elements (CCEs). Each CCE consists of six resource element groups (REGs). Each REG is one PRB in an orthogonal frequency division multiplexing (OFDM) symbol. A REG consists of 12 resource elements (REs), with nine of the REs comprising the DCI payload and three of the REs comprising demodulation reference signals (DMRS).

For each DCI, 1, 2, 4, 8, or 16 CCEs can be allocated. The number of CCEs for a DCI is denoted as the aggregation level (AL). A DCI with an aggregation level L can be mapped to physical resources in a control resource set (CORESET) in a selected BWP.

A UE can be configured with up to three CORESETs on each of up to four BWPs on a serving cell, such as a primary cell (PCell) or secondary cell (SCell). A CORESET can have an index of between 0 and 11. The CORESET 0 is designated as a special coreset that includes the master information block (MIB), the synchronization signals (primary and secondary) and the physical broadcast channel (PBCH), The synchronization signals and PBCH block are collectively referred to as the SSB.

### FIG. 9: CORESET

FIG. 9 provides an example diagram 900 of a channel bandwidth (CBW) 902 that includes a first BWP 904 and a second BWP 906. Each BWP includes a CORESET 908, 910. Each CORESET 908, 910 can have a selected aggregation level L. Aggregation level indicates how many CCEs are allocated for a PDCCH The CORESET can be comprised of L CCEs. A CCE is made up of 6 REGs. A REG is made up of 1 RB and 1 OFDM Symbol, as previously discussed. A simple way to visualize the CCEs is that L is the number of adjacent CCEs used to send the DCI information. However in use, the CCEs may be mapped to REGs using distributed mapping, or interleaving, in which case the CCEs may not be located in adjacent REGs within the CORESET.

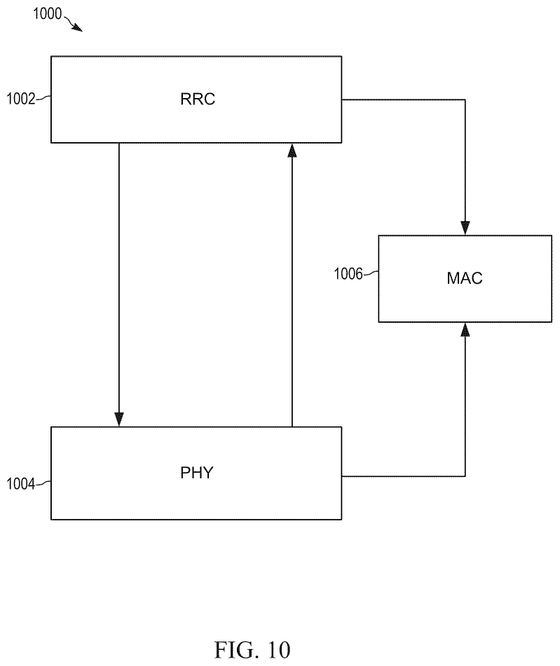

### FIG. 10: Radio Link Monitoring

A UE can monitor the quality of each radio link to each cell using radio link monitoring (RLM). The UE can perform RLM on an active BWP of a primary serving cell (PCell). If carrier aggregation is implemented, and the UE is configured with a secondary cell group (SCG) of one or more SCells, then the UE can also monitor downlink radio link quality on the active DL BWP of the primary SCG cell (PSCell). Different layers can be used to perform the measurements, depending on the speed of the measurement needed, and the amount of information conveyed.

FIG. 10 provides one example illustration 1000 of the layers used for RLM. A PHY layer 1004 can be used to monitor the DL radio quality, and send measurement results to upper layers. For instance, the PHY layer 1004 can be used to monitor an out-of-sync (OOS) and in-sync (IS) indication, and perform beam failure detection (BFD) and report any instances. The IS and OOS indications can be communicated from the PHY layer 1004 to a radio resource control (RRC) layer 1002. The RRC layer 1002 can be used to configure the other layers. For example, the RRC layer 1002 can configure both the PHY layer 1004 for RLF detection and RRC re-establishment when an RLF occurs. The RRC layer 1002 can also configure a MAC layer 1006 for beam failure detection and beam failure recovery. The PHY layer 1004 can report beam failure instances to the MAC layer 1006.

Radio link monitoring of the DL radio quality can be performed using reference signals (RS). The type of reference signals used can be configured by a base station using RRC signaling from the RRC layer 1002. The RLM can be performed using the SSB or channel state information reference signals (CSI-RS) or some combination of the reference signals.

The downlink radio link quality of the primary cell can be monitored by a UE for the purpose of indicating out-of-sync (OOS) or in-sync (IS) status to higher layers. In one example, a DL radio link can be determined to be OOS when the block error rate (BLER) of the PDCCH is 10% or greater. A DL radio link can be determined to be IS when the BLER of the PDCCH is 2% or less. The actual OOS and IS BLER rate can be received from the network in a configuration received at the UE via RRC signaling.

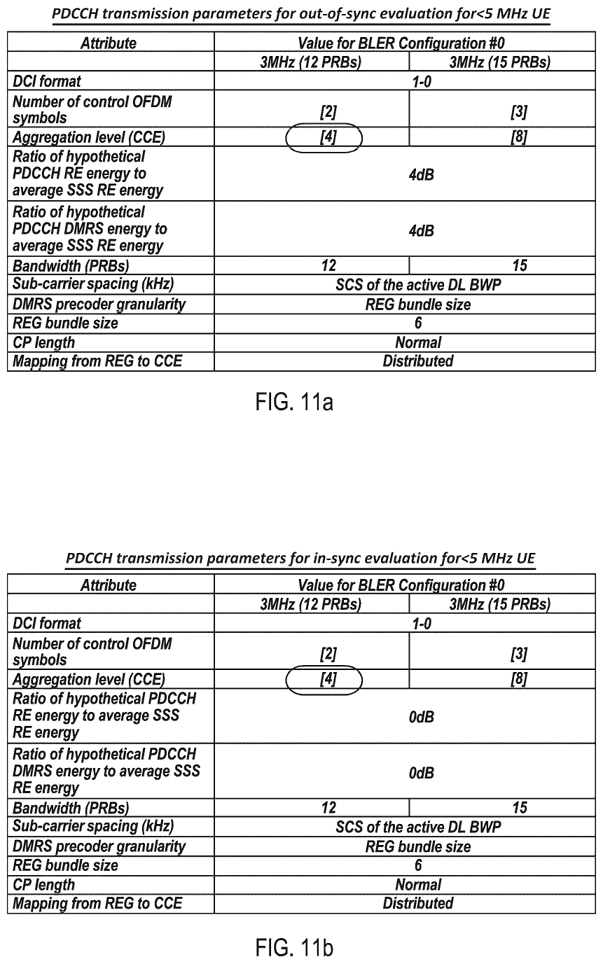

### FIGS. 11a and 11b: PDCCH Tx Parameters for OOS and IS for <5 MHz UE

In recent discussions of the 3GPP NR specification Release 18, an even smaller transmission bandwidth (e.g. 806 in FIG. 8) of 3 MHz, comprising 12 PRBs or 15 PRBs, has been established. For each different transmission bandwidth, a number of transmission parameters can be designated in the 3GPP NR specification. FIGS. 11a and 11b illustrate example PDCCH transmission parameters for out-of-sync (OOS) evaluation for a bandwidth less than 5 MHz at a UE, and for in-sync (IS) evaluation for the less than 5 MHz bandwidth at the UE, respectively.

In FIG. 11a, first table provides an example of PDCCH transmission parameters for OOS evaluation at a UE for a transmission bandwidth of less than 5 MHz. As illustrated, for a BLER configuration #0, a 3 MHz bandwidth signal with 12 PRBs and a 3 MHz bandwidth signal with 15 PRBs is illustrated. The signal can have a DCI format of 1-0, and a number of OFDM symbols of 2 (for 12 PRBs) or 3 symbols (for 15 PRBs). A CCE aggregation level (AL) of 4 is set for 12 PRBs.

Similarly, FIG. 11b a second table provides an example of PDCCH transmission parameters for IS evaluation at a UE for a transmission bandwidth of less than 5 MHz. As illustrated, for a BLER configuration #0, a 3 MHz bandwidth signal with 12 PRBs and a 3 MHz bandwidth signal with 15 PRBs is illustrated. The signal can have a DCI format of 1-0, and a number of OFDM symbols of 2 (for 12 PRBs) or 3 symbols (for 15 PRBs). A CCE aggregation level (AL) of 2 is set for 12 PRBs. Accordingly, an AL of 2 can be used for in-sync evaluation of a PDCCH signal that with a bandwidth that is less than 5 MHz, such as a 3 MHz bandwidth signal.

The DCI format 1-0 designates a number of different procedures. The DCI format 1-0 can be used for scheduling of physical downlink shared channels (PDSCH) in one cell, scheduling the random access response (RAR (Message 2) in the random access procedure (RACH), scheduling contention resolution (Message 4) in the RACH procedure, scheduling the system information block one (SIB1) and other SIB messages, and scheduling paging messages.

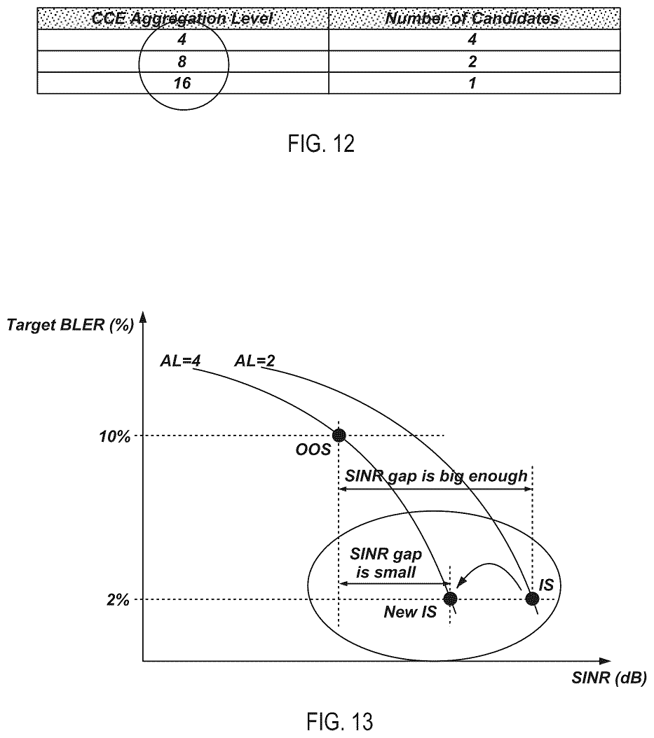

### FIG. 12: CCE Aggregation Levels for CSS Sets

When DCI format 1-0 is used for CORSET #0, it can have different AL assumptions. Table 10.1-1 in 3GPP TS 38.213 Ver. 17.7.0 (September, 2023) and other versions lists CCE aggregation levels and the maximum number of PDCCH candidates per CCE aggregation level for common search space (CSS) sets that are configured by search space SIB1. The Table 10.1-1 is reproduced in FIG. 12. Section 10.1 in the TS 38.213 designates a number of different cases in which the CCE AL in Table 10.1-2 (FIG. 12) are to be used. As shown, the table does not include the option of a CCE AL of 2.

### FIG. 13: BLER vs SINR Gap for OOS and IS PDCCH Transmissions

FIG. 13 illustrates an example of curves for block error rate (BLER) (percent) versus signal to interference plus noise ratio (SINR), in decibels (dB) for a PDCCH transmission with an aggregation level of 4 and an aggregation level of 2. As previously discussed, an AL of 2 is designated in FIG. 11b for in-sync PDCCH transmission. A DL radio link can be determined to be OOS when the block error rate (BLER) of the PDCCH is 10% or greater. A DL radio link can be determined to be IS when the BLER of the PDCCH is 2% or less.

FIG. 13 illustrates the SINR gap, which is the difference in SINR for a PDCCH signal that is OOS (10% BLER) and IS (2% BLER). The SINR gap is one way for a UE to determine when the UE is IS or OOS with the base station. When an AL of 2 is used, there is a sufficiently large SINR gap for the UE to accurately differentiate between being IS and OOS. However, when an AL of 4 is used, the SINR gap is small, and may not be sufficient for the UE to use SINR to distinguish between being IS and OOS. A gap can be considered sufficiently large if the gap is greater than the measurement accuracy. Otherwise, it can be considered too small. In one example, a threshold level of 6 dB may be used to distinguish between sufficiently large and too small. However, this is not intended to be limiting. The measurement accuracy may allow a threshold of between 3 dB and 9 dB, or other threshold levels depending on system limitations.

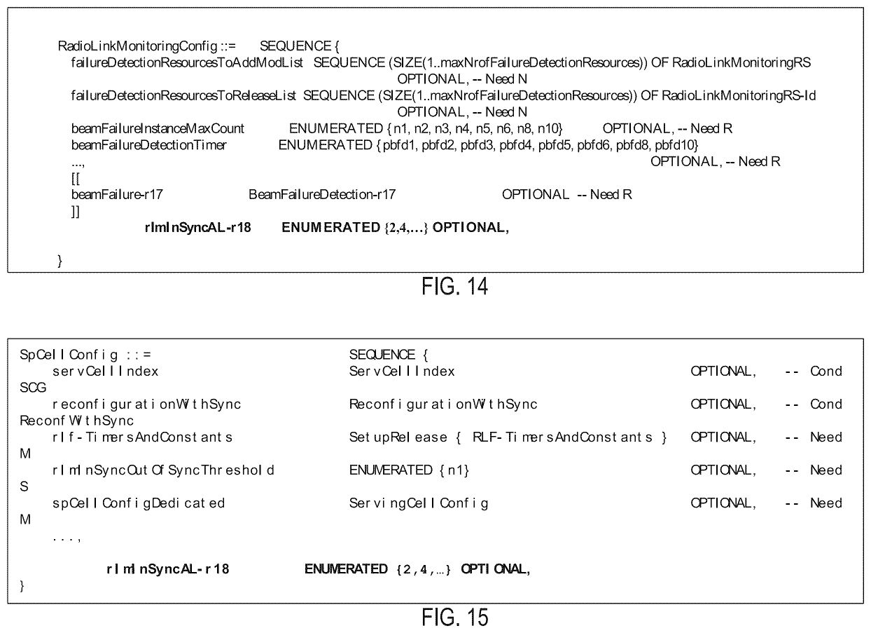

### FIG. 14: Pseudo-code for RLM for Network Configuration of AL Level

In accordance with one embodiment of the invention, a NR network can be configured to indicate the AL level for OOS and IS evaluation in RLM resource configuration. FIG. 14 illustrates an example pseudo-code of an information element for RRC signaling to configure AL for OOS and IS evaluation in RLM resource configuration according to some embodiments. In this example, a radio link monitoring config (RadioLinkMonitoringConfig) IE includes an optional rImInSyncAL parameter that is enumerated. The network can designate the in-sync (IS) AL for OOS and IS evaluation in the RLM resource configuration. In this example, the network can select an AL of 2, 4, 8, 16, or another desired value. This example provides a cell specific configuration for IS AL used for RLM. The AL value may be selected based on the SINR vs BLER of the PDCCH, as previously discussed in FIG. 13. Alternatively, different IS AL levels may be selected based on other network requirements, such as those recited in Section 10.1 of the 3GPP TS 38.213, such as Version 17.7.0 (September 2023) or other versions. In this example, the rimInSyncAL is designated for UEs that are configured to use Release 18 of the 3GPP NR specification.

### FIG. 15: Pseudo-Code for IE for RRC Signaling to Configure AL for OOS and IS Evaluation

FIG. 15 illustrates an example pseudo-code of an information element for RRC signaling to configure AL for OOS and IS evaluation in RLM resource configuration according to some embodiments. In this example, an SPCell config IE (SpCellConfig) is used for the network to designate the rimInSyncAL for Release 18 configured UEs. As in FIG. 14, the network can designate an AL of 2, 4, 8, 16 or another desired value. Using the SpCellConfig IE also allows for cell specific configuration for the IS AL level of RLM.

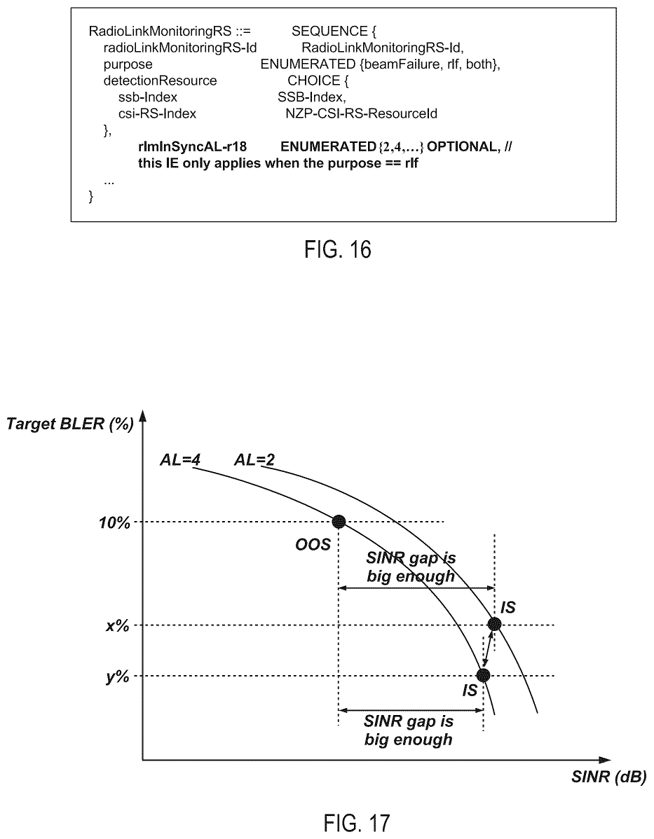

### FIG. 16: Pseudo-Code for Network Indication-Based AL Level Selection for RLM

FIG. 16 an example pseudo-code of an information element for network indication-based AL level selection for RLM according to some embodiments. In this example, an RLM monitoring IE (e.g., RadioLinkMonitoringRS) can be used to provide a reference signal specific configuration for the AL level of RLM. When the network configures the reference signal used for radio link monitoring, the AL parameter can be configured for each RLM-RS. As illustrated in FIG. 16, an rImInSyncAL-r18 parameter can be used for the network to optionally designate an AL level for the UE. It is noted that the IE in this example only applies when the purpose is for radio link failure (RLF).

### FIG. 17: BLER vs SINR Gap for AL Level Selection for RLM

In another example, a UE can be configured to receive an AL parameter from a network via RRC signaling for OOS and IS evaluation in RLM resource configuration. In this example, the AL parameter can be differently applied according to a target BLER or a target SINR. FIG. 17 provides an example illustration of two PDCCH curves showing the BLER (%) vs SINR (dB). In this example, a first PDCCH curve is illustrated with AL=4 and a second PDCCH curve is illustrated with AL=2. When the target BLER is x %, the UE can apply the AL parameter n1. In this example, n1=2. When the target BLER is y %, the UE can apply the AL parameter n2, which in this case n2=4, where x>y. In one embodiment, the network can configure one specific target BLER associated with an AL parameter. Alternatively, the target BLER can be predefined. For example, a specific target BLER associated with an AL parameter can be set in the 3GPP NR specification. By applying the different AL parameter based on the target BLER, the SINR gap can be sufficiently big to enable the UE to differentiate between when the PDCCH signal reception at the UE is OOS (e.g., a BLER greater than or equal to 10%) or IS (e.g., a BLER less than or equal to 2%).

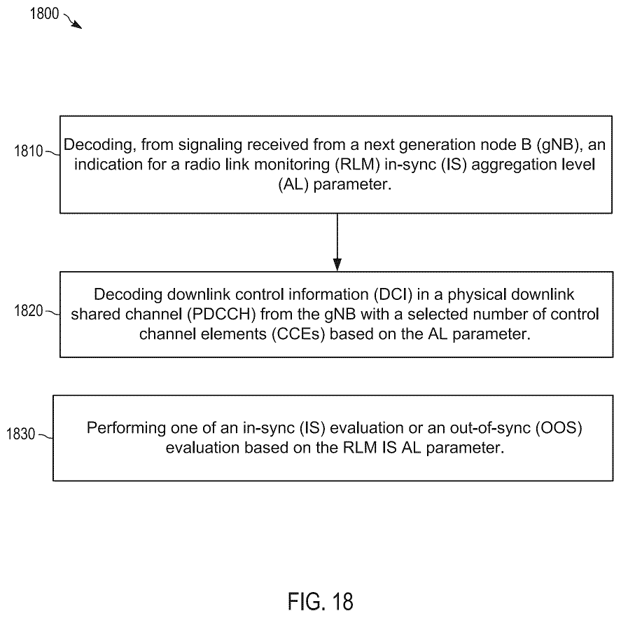

### FIG. 18: Flow Chart for a Method for Setting an Aggregation Level

FIG. 18 illustrates a flow chart of an example of a method for setting an aggregation level, according to some embodiments. The method shown in FIG. 18 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 1800 for setting an aggregation level is disclosed. The method 1800 comprises decoding, from signaling received from a next generation node B (gNB), an indication for a radio link monitoring (RLM) in-sync (IS) aggregation level (AL) parameter, as shown in block 1810. Downlink control information (DCI) can be decoded in a physical downlink shared channel (PDCCH) from the gNB with a selected number of control channel elements (CCEs) based on the AL parameter, as shown in block 1820. One of an in-sync (IS) evaluation or an out-of-sync (OOS) evaluation can be performed based on the RLM IS AL parameter, as shown in block 1830.

In some embodiments, the signaling received from the gNB can be RRC control signaling. The UE can be determined in-sync when an SINR gap between a BLER versus SINR of the DCI decoded in the PDCCH, as measured at a first OOS BLER level relative to a second IS BLER level, is less than a selected threshold.

In some embodiments, the OOS BLER level can be between 5 and 15 percent. The IS BLER level can be between 0.1 and 4 percent.

In some embodiments, the signaling received from the gNB is for a cell specific configuration for an AL level of RLM. In another embodiment, the signaling received from the gNB is an RLM configuration information element (IE). Alternatively, the signaling received from the gNB can be an SpCellConfig IE.

In some embodiments, the signaling received from the gNB is for a reference signal specific configuration. The AL parameter can be configured for each RLM reference signal (RLM-RS).

In some embodiments, the signaling received from the gNB is a radio link monitoring reference signal IE.

In some embodiments, the indicated RLM IS AL consists of one of 2, 4, 8 or 16.

In some embodiments, the indicated RLM IS AL indicates an AL parameter to use based on one or more target block error rates of a DL signal in the PDCCH or one or more target signal to interference plus noise ratio (SINR) parameters of the DL signal in the PDCCH.

In some embodiments, a power boosting reduction of a selected amount can be applied when performing the IS evaluation, wherein the selected amount is predefined in a specification or configured by a network, and the selected amount is cell specific or reference signal specific.

In some embodiments, an apparatus can be configured to cause a UE to perform any of the methods disclosed herein.

In some embodiments, a UE can be configured to perform any of the operations described herein.

In some embodiments, a next generation node B (gNB) can be configured to perform any of the operations described herein.

In some embodiments, a computer program product, comprising computer instructions which, when executed by one or more processors, can perform any of the operations described herein.

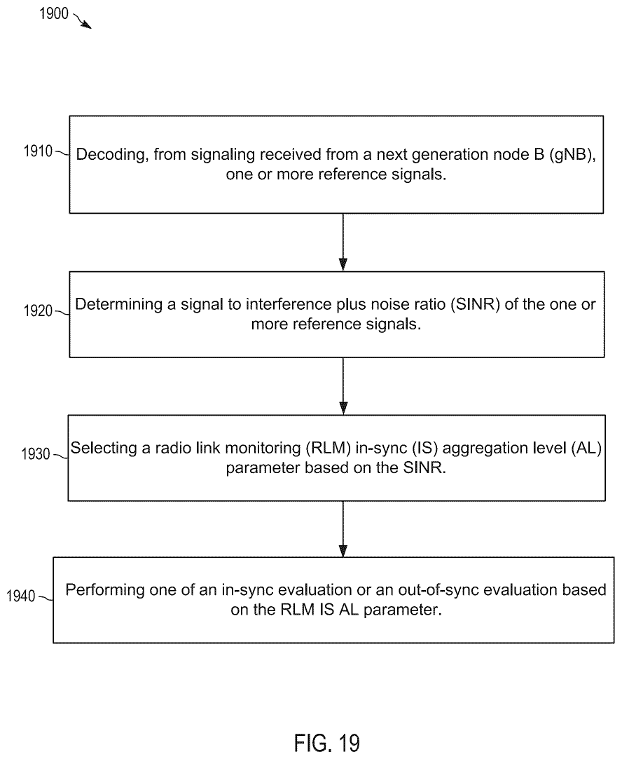

### FIG. 19: Flow Chart for a Method for Setting an Aggregation Level at a UE

FIG. 19 illustrates a flow chart of an example of a method for setting an aggregation level at a UE, according to some embodiments. The method shown in FIG. 19 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 1900 for setting an aggregation level is disclosed. The method 1900 comprises decoding from signaling received from a next generation node B (gNB), one or more reference signals, as shown in block 1910. An SINR of the one or more reference signals can be determined, as shown in block 1920. An RLM IS AL parameter can be selected based on the SINR, as shown in block 1930. One of an in-sync evaluation or an out-of-sync evaluation based on the RLM IS AL parameter.

In some embodiments, DCI in a PDCCH can be decoded. The PDCCH can have a selected number of CCEs based on the AL parameter.

In some embodiments, the one or more reference signals are CSI-RS. Alternatively, the one or more reference signals can be in the SSB. For example, demodulation reference signals (DMRS) in the physical broadcast channel (PBCH) in the SSB can be used as reference signals. Or the secondary synchronization signal (SSS) in the SSB can be used as reference signals.

In some embodiments, the UE can perform RLM using an SSB and calculate the SINR based on the SSB.

In some embodiments, the AL parameter can be selected relative to a threshold level of the SINR. The threshold level can be predefined in a specification, such as the 3GPP specification, or configured by a network. The threshold level can be cell specific or reference level specific.

In some embodiments, one or more processors of the UE can be further configured to determine a reference signal received power (RSRP) or a reference signal received quality (RSRQ) from the one or more signals to determine the AL parameter.

### EXAMPLES

In some embodiments, an apparatus of a user equipment (UE) comprises one or more processors, coupled to a memory, configured to: decode, from signaling received from a next generation node B (gNB), an indication for a radio link monitoring (RLM) in-sync (IS) aggregation level (AL) parameter; decode downlink control information (DCI) in a physical downlink shared channel (PDCCH) from the gNB with a selected number of control channel elements (CCEs) based on the AL parameter; and perform one of an in-sync (IS) evaluation or an out-of-sync (OOS) evaluation based on the RLM IS AL parameter.

In some embodiments, the signaling received from the gNB is radio resource control signaling.

In some embodiments, the one or more processors are further configured to determine the UE is in-sync when an SINR gap between a block error rate (BLER) versus SINR of the DCI decoded in the PDCCH, as measured at a first OOS BLER level relative to a second IS BLER level, is less than a selected threshold.

In some embodiments, the one or more processors are further configured to apply a power boosting reduction of a selected amount when performing the IS evaluation, wherein the selected amount is predefined in a specification or configured by a network, and the selected amount is cell specific or reference signal specific.

In some embodiments, an apparatus of a UE can include one or more processors, coupled to a memory, that are configured to: decode, from signaling received from a next generation node B (gNB), one or more reference signals; determine a signal to interference plus noise ratio (SINR) of the one or more reference signals; select a radio link monitoring (RLM) in-sync (IS) aggregation level (AL) parameter based on the SINR; and perform one of an in-sync evaluation or an out-of-sync evaluation based on the RLM IS AL parameter.

In some embodiments, the one or more processors are further configured to decode downlink control information (DCI) in a physical downlink shared channel (PDCCH) from the gNB with a selected number of control channel elements (CCEs) based on the AL parameter.

In some embodiments, the one or more reference signals are channel state information reference signals (CSI-RS). Alternatively, the reference signals can be used in the synchronization signal block (SSB). For example, demodulation reference signals (DMRS) in the physical broadcast channel (PBCH) in the SSB can be used as reference signals. Or the secondary synchronization signal (SSS) in the SSB can be used as reference signals.

In some embodiments, the UE performs RLM using a synchronization signal block (SSB) and calculates the SINR based on the SSB.

In some embodiments, the one or more processors are further configured to select the AL parameter relative to a threshold level of the SINR, wherein the threshold level is predefined in a specification or configured by a network. The threshold level can be cell specific or reference signal specific.

In some embodiments, the one or more processors are further configured to determine a reference signal received power (RSRP) or a reference signal received quality (RSRQ) from the one or more signals to determine the AL parameter.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus of a user equipment (UE), the apparatus comprising:
one or more processors, coupled to a memory, configured to:
decode, from signaling received from a next generation node B (gNB), an indication for a radio link monitoring (RLM) in-sync (IS) aggregation level (AL) parameter;
decode downlink control information (DCI) in a physical downlink control channel (PDCCH) from the gNB with a selected number of control channel elements (CCEs) based on the AL parameter; and
perform one of an in-sync (IS) evaluation or an out-of-sync (OOS) evaluation based on the RLM IS AL parameter.

2. The apparatus of claim 1, wherein the signaling received from the gNB is radio resource control signaling.

3. The apparatus of claim 1, wherein the one or more processors are further configured to determine the UE is in-sync when an SINR gap between a block error rate (BLER) versus SINR of the DCI decoded in the PDCCH, as measured at a first OOS BLER level relative to a second IS BLER level, is less than a selected threshold.

4. The apparatus of claim 3, wherein the OOS BLER level is between 5 and 15 percent and the IS BLER level is between 0.1 and 4 percent.

5. The apparatus of claim 1, wherein the signaling received from the gNB:
is for a cell specific configuration for an AL level of RLM; or
is an RLM configuration information element (IE); or
is an SpCellConfig information element (IE); or
is for a reference signal specific configuration, and the AL parameter is configured for each RLM reference signal (RLM-RS); or
the signaling received from the gNB is a radio link monitoring reference signal information element (IE).

6.-9. (canceled)

10. The apparatus of claim 1, wherein the indicated RLM IS AL consists of one of 2, 4, 8, or 16.

11. The apparatus of claim 1, wherein the indicated RLM IS AL indicates an AL parameter to use based on one or more target block error rates of a DL signal in the PDCCH or one or more target signal to interference plus noise (SINR) parameters of the DL signal in the PDCCH.

12. The apparatus of claim 1, wherein the one or more processors are further configured to apply a power boosting reduction of a selected amount when performing the IS evaluation, wherein the selected amount is predefined in a specification or configured by a network, and the selected amount is cell specific or reference signal specific.

13. An apparatus of a user equipment (UE), the apparatus comprising:
one or more processors, coupled to a memory, configured to:
decode, from signaling received from a next generation node B (gNB), one or more reference signals;
determine a signal to interference plus noise ratio (SINR) of the one or more reference signals;
select a radio link monitoring (RLM) in-sync (IS) aggregation level (AL) parameter based on the SINR; and
perform one of an in-sync evaluation or an out-of-sync evaluation based on the RLM IS AL parameter.

14. The apparatus of claim 13, wherein the one or more processors are further configured to decode downlink control information (DCI) in a physical downlink control channel (PDCCH) from the gNB with a selected number of control channel elements (CCEs) based on the AL parameter.

15. The apparatus of claim 13, wherein the one or more reference signals are channel state information reference signals (CSI-RS).

16. The apparatus of claim 13, wherein the one or more reference signals are synchronization signal block (SSB) reference signals comprising demodulation reference signals (DMRS) in a physical broadcast channel (PBCH) in the SSB or a secondary synchronization signal (SSS) in the SSB.

17. The apparatus of claim 13, wherein the UE performs RLM using channel state information reference signals (CSI-RS) and calculates the SINR based on the CSI-RS.

18. The apparatus of claim 13, wherein the UE performs RLM using a synchronization signal block (SSB) and calculates the SINR based on the SSB.

19. The apparatus of claim 13, wherein the one or more processors are further configured to:
select the AL parameter relative to a threshold level of the SINR, wherein the threshold level is predefined in a specification or configured by a network; or
determine a reference signal received power (RSRP) or a reference signal received quality (RSRQ) from the one or more signals to determine the AL parameter.

20. The apparatus of claim 19, wherein the threshold level is cell specific or reference signal specific.

21. (canceled)

22. A method for setting an aggregation level, comprising:
decoding, at a user equipment (UE), from signaling received from a next generation node B (gNB), an indication for a radio link monitoring (RLM) in-sync (IS) aggregation level (AL) parameter;
decoding downlink control information (DCI) in a physical downlink control channel (PDCCH) from the gNB with a selected number of control channel elements (CCEs) based on the AL parameter; and
performing one of an in-sync (IS) evaluation or an out-of-sync (OOS) evaluation based on the RLM IS AL parameter.

23. The method of claim 22, wherein the signaling received from the gNB is radio resource control signaling.

24. The method of claim 22, further comprising determining the UE is in-sync when an SINR gap between a block error rate (BLER) versus SINR of the DCI decoded in the PDCCH, as measured at a first OOS BLER level relative to a second IS BLER level, is less than a selected threshold.

25. The method of claim 24, wherein the OOS BLER level is between 5 and 15 percent and the IS BLER level is between 0.1 and 4 percent.

26. The method of claim 22, wherein the signaling received from the gNB is for a cell specific configuration for an AL level of RLM.

27-47. (canceled)
